(19) United States
(12) Patent Application Publication
(10) Pub. No.: US 2012/0281423 A1
(43) Pub. Date: Nov. 8, 2012

(54) ILLUMINATED INDICATOR DISPLAY

(75) Inventor: Erik Anthony Wippler, Canton, MI (US)

(73) Assignee: Toyota Motor Engineering & Manufacturing North America, Inc., Erlanger, KY (US)

(21) Appl. No.: 13/098,667

(22) Filed: May 2, 2011

(51) Int. Cl. B60Q 1/00

(52) U.S. Cl. 362/489

(57) ABSTRACT

The present invention provides for an illuminated indicator display apparatus for use in an automotive vehicle display or dashboard. The illuminated indicator includes a light source, at least one baffle disposed adjacent the light source, a first panel disposed opposite the light source and connected to the at least one baffle, and a second panel spaced apart at a predetermined distance and positioned parallel to the first panel. The first panel or the second panel further including printed or painted graphics (such as low fuel indicator, seatbelt warning, etc.) viewable to the operator of an automotive vehicle. The baffle is made of an opaque material operable to block light from the light source. The second panel is tinted dark operable only to allow a portion of the light from a light source to pass through the second panel thereby further dimming the light able to pass through the second panel.

### FIELD OF THE INVENTION

This invention relates generally to illuminated indicator displays. In particular, this invention relates to an illuminated indicator display apparatus for use in an automotive vehicle to improve aesthetics.

### BACKGROUND OF THE INVENTION

Indicator lights are commonly used on automotive vehicle dashboards and display panels to inform operators of the vehicle of warnings or other vehicle occurrences such as low fuel, maintenance, seatbelt warnings, low windshield washer fluid, etc. However, these indications are commonly a combi-meter or HVAC control panel and frequently, the graphics themselves are at least partially visible to the user even when the back light is off. Viewing of the graphic connected with the illuminated indicator display when the indicator light is not in operation is not aesthetically pleasing to the operator of a vehicle. Accordingly, there exists a need to provide for an illuminated indicator display and graphic apparatus hidden from view of the operator of a vehicle when the light source used to illuminate the graphic is not in use.

### SUMMARY OF THE INVENTION

The present invention provides for an illuminated indicator display apparatus for use in an automotive vehicle display or dashboard. The illuminated indicator includes a light source, at least one baffle disposed adjacent the light source, a first panel disposed opposite the light source and connected to the at least one baffle, and a second panel spaced apart at a predetermined distance and positioned parallel to the first panel. The first panel or the second panel further including printed or painted graphics (such as low fuel indicator, seatbelt warning, etc.) viewable to the operator of an automotive vehicle. The baffle is made of an opaque material operable to block light from the light source. The second panel is tinted dark operable only to allow a portion of the light from a light source to pass through the second panel thereby further dimming the light able to pass through the second panel.

### BRIEF DESCRIPTION OF THE DRAWINGS

FIG. 1 is a perspective environmental view of the indicator lights on a typical automotive dashboard assembly; and

FIG. 2 is a cross sectional view of the illuminated indicator display apparatus.

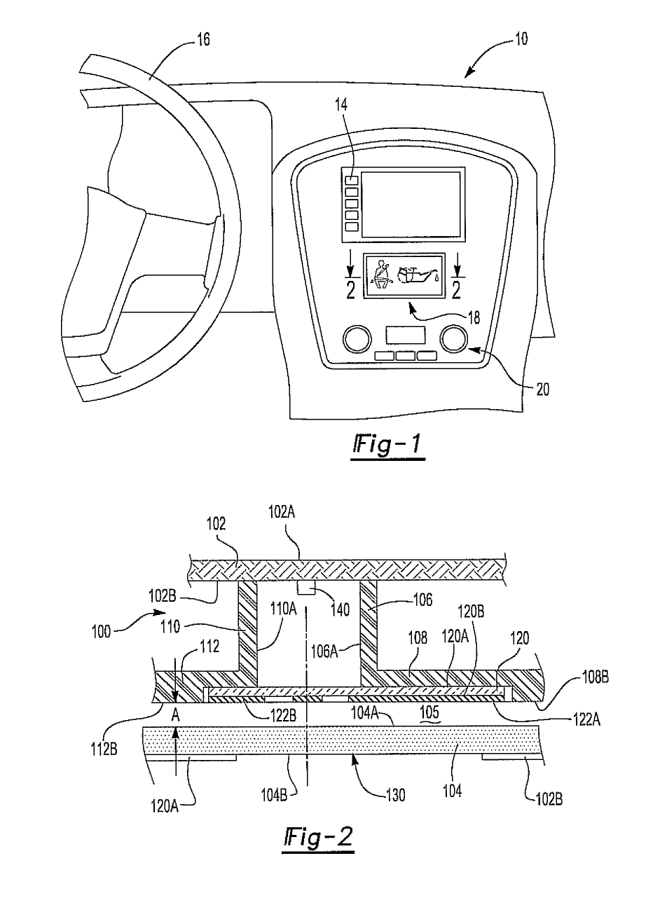

### DETAILED DESCRIPTION OF THE INVENTION

The present invention provides for an improved apparatus for displaying indicator graphics on a display panel of a dashboard. The display apparatus includes a light source, at least one baffle, a first panel, and a second panel. The combination of these elements provides for a surface having a clean appearance free of any gaps displayed to the user.

A base 102 having an upper surface 102a and a lower surface 102b is provided as the main structure of the invention. The base 102 may optionally be a printed circuit board or other support means. A light source 140 is provided mounted to the lower surface 102b of the base 102. The light source 140 is attached to a lower surface 102b of the base 102 by means of an adhesive or other hardware connecting means. The light source 140, in the present embodiment, is an LED.

In the present embodiment, baffles 106, 110 are provided extending away from the lower surface 102b of the base 102. The baffles 106, 110 are provided to block stray light emitting from the light source 140. The baffles 106, 110 and all extending parts therefrom are at least opaque to prevent light from the light source 140 from reaching undesired locations. The baffle 106 includes an inner surface 106a. In an alternative embodiment, the baffle 106 is made of any material and the inner surface 106a is painted or coated with an opaque material. The baffle 110 includes an inner surface 110a. In an alternative embodiment, the baffle 110 is made of any suitable material and the inner surface 110a of the baffle 110 is coated or painted with an opaque material.

The baffles 106, 110 further include legs 108, 112. The leg 108 extending at a right angle away from the baffle 106 also functions as a support. The leg 112 extending away from and at a right angle away from the baffle 110 is also used as a support. The legs 108, 112 are made of an at least opaque material, or alternatively, are coated in an opaque material. The legs 108, 112 are provided to block stray light from the light source 140.

In the present embodiment, the legs 108, 112 provide as a holding structure for a panel 120. The panel 120 is either made of a plastic or polymer-like material or, alternatively, the panel 120 is more of a sheet material having high flexibility. In the present embodiment, the panel 110 is clear. Alternatively, the panel 120 is semitransparent having a milky white appearance.

In the present embodiment, the panel 120 includes an upper surface 120a and a lower surface 120b. As shown in FIG. 2, the upper surface 120a is positioned closest to the light source 140. The lower surface 120b includes printing or painting of graphics on the panel 120. The graphics 122a, 122b are graphics used to indicate to the user of the vehicle various present conditions of the vehicle (i.e., low fuel, seatbelt warning, maintenance request, etc.). The graphics 122a, 122b are either painted or printed onto the lower surface 120b of the panel 120. The graphics 122a, 122b are made of an opaque material thereby preventing light from passing through the printed graphic 122a, 122b.

Provided spaced apart at a predetermined distance A is a substrate panel 104. The panel 104 includes an upper surface 104a and a lower surface 104b. The panel 104 is made of a polymer or plastic-like material having rigid characteristics. The panel 104 is made of a semitransparent or translucent material giving a smoky or dark tinted effect to the panel 104. The lower surface 104b of the panel 104 further includes graphics 120a, 120b. The graphics 120a, 120b are used as indications to the operator of the vehicle of present conditions within the vehicle. The graphics 120a, 120b are made of an opaque material thereby preventing any light from passing through the graphic.

The upper surface 104a of the panel 104 is provided spaced apart at a predetermined distance A from the lower surface 112b, the lower surface 108b, and the printed graphics 122a, 122b of the panel 120. In the present embodiment, the predetermined distance A ranges between 0.5-5 mm. The required predetermined distance A between the upper surface 104a of the panel 104 and the graphics 122a, 122b provides for a small air gap between the panel 104 and the graphics 122a, 122b. The air gap 105 is present to help mask or hide the appearance of the graphics behind the panel 104 when the light source 140 is in the off position. The light source 140 is placed inside the baffles 106, 110 to illuminate the graphics 122a, 122b, 120a, 120b when needed. When the light source 140 is illuminated, the graphics 120a, 120b, 122a, 122b appear through the smoked panel 104 and are displayed to the end user at point 130.

This invention is not restricted to the illustrative examples and embodiments described above. The embodiments are not intended as limitations on the scope of the invention. Methods, apparatus, compositions, and the like described herein are exemplary and not intended as limitations on the scope of the invention. Changes therein and other uses will occur to those skilled in the art. The scope of the invention is defined by the scope of the appended claims.

1. An illuminated indicator display apparatus for use in an automotive vehicle display or dashboard, the display apparatus comprising:
a light source;
at least one baffle disposed adjacent the light source;
a first panel disposed opposite the light source and connected to the at least one baffle; and
a second panel spaced apart a predetermined distance and positioned parallel to the first panel.

2. The display apparatus of claim 1, wherein the predetermined distance between the second panel and the first panel ranges between 0.1-5 millimeters.

3. The display apparatus of claim 2, wherein the at least one baffle is made of an opaque material operable to block light from the light source.

4. The display apparatus of claim 3, wherein the at least one baffle includes a first section and a second section.

5. The display apparatus of claim 4, wherein the first section of the at least one baffle is positioned adjacent the light source.

6. The display apparatus of claim 4, wherein the second section of the at least one baffle is positioned in parallel to the first panel.

7. The display apparatus of claim 6, wherein the first panel is mounted to the second section of the at least one baffle.

8. The display apparatus of claim 1, wherein the first panel is transparent operable to allow all light from the light source to pass through the first panel.

9. The display apparatus of claim 1, wherein the first panel is translucent operable to allow a portion of the light from the light source to pass through the first panel.

10. The display apparatus of claim 1, wherein the second panel is translucent operable to allow a portion of the light from the light source to pass through the second panel.

11. The display apparatus of claim 1, wherein the second panel is tinted dark operable to allow a portion of the light from the light source to pass through the second panel and further dimming the light able to pass through the second panel.

12. The display apparatus of claim 1, wherein the first panel includes a first surface and a second surface.

13. The display apparatus of claim 12, wherein the first surface of the first panel further includes graphics viewable by the user.

14. The display apparatus of claim 12, wherein the second surface of the first panel further includes graphics viewable by the user.

15. The display apparatus of claim 1, wherein the second panel includes a first surface and a second surface.

16. The display apparatus of claim 15, wherein the first surface of the second panel further includes graphics on the first surface viewable by the user.

17. The display apparatus of claim 15, wherein the second surface of the second panel further includes graphics on the first surface viewable by the user.

18. An illuminated indicator display apparatus for use in an automotive vehicle display or dashboard, the display apparatus comprising:
a light source;
at least one baffle disposed adjacent the light source operable to block stray light produced by the light source;
a first panel disposed opposite the light source and connected to the at least one baffle, the first panel being transparent or translucent allowing light from the light source to pass through the first panel;
a second panel spaced apart a predetermined distance and positioned parallel to the first panel, the second panel being transparent or translucent allowing light from the light source to pass through the second panel;
the first panel or the second panel further include graphics viewable by the user, wherein the predetermined distance is large enough to prevent the user from viewing the graphics of the first panel or the second panel when the light source is off.

19. The display apparatus of claim 18, wherein the predetermined distance between the second panel and the first panel ranges between 0.1-5 millimeters.
